(19) United States
(12) Patent Application Publication
(10) Pub. No.: US 2020/0282707 A1
(43) Pub. Date: Sep. 10, 2020

(54) Bulletproof Panel

(71) Applicant: IDEL CO., LTD., Chilgok-gun (KR)

(72) Inventors: Jae Sik Lee, Daegu (KR); Ki Sung Nam, Cheongju-si (KR); Yong Hyeok Choi, Busan (KR); Dong Wook Shon, Daejeon (KR); Dong Ho Kim, Busan (KR)

(21) Appl. No.: 16/668,466

(22) Filed: Oct. 30, 2019

(30) Foreign Application Priority Data
Mar. 8, 2019 (KR) 10-2019-0026978

(51) Int. Cl. B32B 17/10; B32B 27/36; F41H 5/04

(52) U.S. Cl. CPC B32B 17/10752; B32B 17/10779; B32B 27/365; B32B 2571/02; B32B 2369/00; B32B 2367/00; B32B 2305/72; F41H 5/0407

(57) ABSTRACT

Disclosed is a bulletproof panel that can replace glass of a vehicle, an elevator, a meeting room, a ticket booth, or the like. The bulletproof panel includes a base layer, a reinforcing layer provided on each of opposite sides of the base layer, and an adhesive layer provided on the base layer and each of the reinforcing layers and made of a UV-curable urethane resin. The bulletproof panel is characterized in that when the panel is impacted by a bullet, the base layer breaks and absorbs a rotational force of the bullet, while the reinforcing layers provided on respective opposite sides of the base layer suppress broken pieces of the base layer from scattering. Thus, the bulletproof panel can exhibit an excellent bulletproof effect because the bullet is fixed in the base layer and does not penetrate therethrough, while preventing broken pieces generated by the bullet from scattering.

### CROSS REFERENCE TO RELATED APPLICATION

The present application claims priority to Korean Patent Application No. 10-2019-0026978, filed Mar. 8, 2019, the entire contents of which is incorporated herein for all purposes by this reference.

### BACKGROUND OF THE INVENTION

### Field of the Invention

The present disclosure relates generally to a bulletproof panel. More particularly, the present disclosure relates to a bulletproof panel in which when the panel is impacted by a bullet, a base layer breaks and absorbs a rotational force of the bullet, while reinforcing layers provided on respective opposite sides of the base layer suppress broken pieces of the base layer from scattering. Thus, the bulletproof panel can exhibit an excellent bulletproof effect because the bullet is fixed in the base layer and does not penetrate therethrough, while preventing broken pieces generated by the bullet from scattering.

### Description of the Related Art

Before the development of bulletproof panels made of plastic materials, bulletproof glass was generally used. Bulletproof glass is composed of layers of colorless transparent bulletproof films (e.g., polyester films) laminated between layers of ordinary glass. Bulletproof glass is resistant to damage and penetration when impacted by a strong external force. These characteristics have led to wide application in various facilities and vehicles to protect human life or property.

One example of bulletproof glass manufactured according to known techniques needs to have a thickness of greater than at least 34 mm to exhibit a bulletproof effect. In particular, in order to achieve a desired bulletproof effect, a thickness of greater than 45 mm is needed.

This is because the physical properties of glass, which is used as a main component of typical bulletproof glass, are very weak. To solve this drawback, bulletproof panels using a synthetic resin component have been developed in place of glass having weak physical properties. One example of bulletproof panels using a synthetic resin component has main functions such as blocking impact of attack, blocking noise, providing thermal insulation, blocking introduction of foreign substances and projectiles.

Technologies for installing or injecting various reinforcement materials inside a bulletproof panel have been developed to perform such functions. However, installing of the reinforcement materials may be demanding and may give rise to issues such as increased weight, increased cost, and structural complexity.

In addition, due to the fact that a material itself constituting a typical bulletproof panel is an opaque material, or that it is difficult to secure transparency due to frequent scratching even when a transparent material is used, these materials may be not suitable as materials for replacing a glass portion of a vehicle or a glass portion of an elevator.

Therefore, there is a demand for development of a bulletproof panel that can secure excellent bulletproof performance, while securing thinness, noise blocking, thermal insulation improvement, strength increase, and transparency.

The foregoing is intended merely to aid in the understanding of the background of the present invention, and is not intended to mean that the present invention falls within the purview of the related art that is already known to those skilled in the art.

Document of Related Art

(Patent document 1) Korean Patent No. 10-1258388 (2013.04.19)

### SUMMARY OF THE INVENTION

Accordingly, the present invention has been made keeping in mind the above problems occurring in the related art, and an objective of the present invention is to provide a bulletproof panel in which when the panel is impacted by a bullet, the bullet is fixed in a base layer and does not penetrate therethrough, thus exhibiting an excellent bulletproof effect, while preventing broken pieces generated by the bullet from scattering.

In order to achieve the above objective, according to one aspect of the present invention, there is provided a bulletproof panel, including: a base layer; a reinforcing layer provided on each of opposite sides of the base layer; and an adhesive layer provided between the base layer and each of the reinforcing layers, and made of a UV-curable urethane resin.

In a preferred embodiment, the base layer may be made of polycarbonate or polymethyl methacrylate.

In a preferred embodiment, the base layer may have a thickness of 5 to 20 mm.

In a preferred embodiment, the reinforcing layer may be made of one selected from the group consisting of polymethyl methacrylate, polycarbonate, acrylonitrile butadiene styrene copolymer, and tempered glass.

In a preferred embodiment, the reinforcing layer may have a thickness of 5 to 15 mm.

In a preferred embodiment, the adhesive layer may include a metallic wire mesh.

The bulletproof panel having the configuration described above provides an advantage of exhibiting an excellent bulletproof effect because when the panel is impacted by a bullet, the bullet is fixed in the base layer and does not penetrate therethrough, and of exhibiting an excellent effect of preventing broken pieces generated by the bullet from scattering.

The present invention provides another advantage of securing transparency by provision of the base layer and the reinforcing layers made of a transparent material, and of providing a thin structure including a metallic wire mesh, thus exhibiting an excellent effect without causing a reduction in bulletproof performance.

### BRIEF DESCRIPTION OF THE DRAWINGS

The above and other objectives, features, and other advantages of the present invention will be more clearly understood from the following detailed description when taken in conjunction with the accompanying drawings, in which:

FIG. 1 is an exploded perspective view showing a bulletproof panel disclosed.

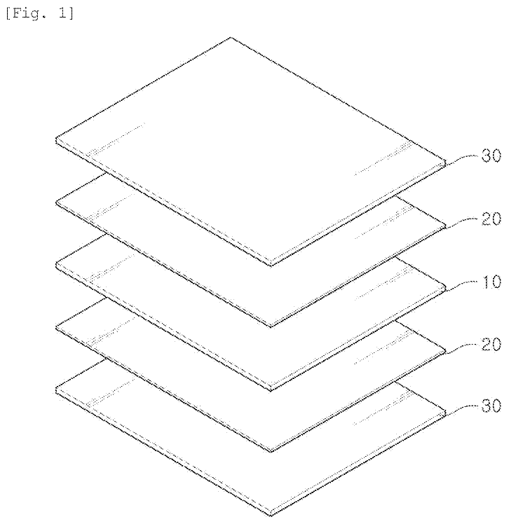

### DETAILED DESCRIPTION OF THE INVENTION

Hereinbelow, exemplary embodiments of the present invention embodiments of the present invention and the physical properties of each component will be described in detail such that the invention can be easily embodied by one of ordinary skill in the art to which this invention belongs. Therefore, the embodiments of the present invention should not be construed as limiting the spirit and scope of the present invention.

A disclosed bulletproof panel includes a base layer 10, a reinforcing layer 30 provided on each of opposite sides of the base layer 10, and an adhesive layer 20 provided between the base layer 10 and each of the reinforcing layers 30 and made of a UV-curable urethane resin.

The base layer 10 is made of polycarbonate or polymethyl methacrylate having a thickness of 5 to 20 mm. In the disclosed bulletproof panel having the above configuration in which the reinforcing layer 30 is provided on each of opposite first and second sides of the base layer 10, when a bullet penetrating into the base layer 10 through the reinforcing layer 30 impacts and breaks the base layer 10, the reinforcing layer 30 on the second side of the base layer causes broken pieces of the base layer 10 to remain together without scattering. Due to this, a rotational force of the bullet is absorbed and the bullet does not penetrate through the base layer 10, whereby a desired bulletproof effect is obtained.

When the thickness of the base layer 10 is less than 5 mm, the bullet effect of the bulletproof panel is lowered. When the thickness of the base layer 10 is greater than 20 mm, the thickness of the base layer 10 is too large as compared to a bullet. In this case, broken pieces tend to be formed, and thus, bulletproof effect of the bulletproof panel may be undesirably lowered.

The reinforcing layer 30 is provided on each of the opposite sides of the base layer 10 at a thickness of 5 to 15 mm. The reinforcing layer 30 is made of one selected from the group consisting of polymethyl methacrylate, polycarbonate, acrylonitrile butadiene styrene copolymer, and tempered glass. The reinforcing layer 30 serves to suppress a phenomenon where the base layer 10 is broken by a bullet to provide a panel having a bulletproof effect.

In one example, when the reinforcing layer 30 is made of polymethyl methacrylate, polycarbonate, or acrylonitrile butadiene styrene copolymer, it is preferable that the thickness of the reinforcing layer 30 is 10 to 15 mm. Furthermore, it is more preferable that hard coating is applied onto the surface of the reinforcing layer 30 to suppress transparency degradation due to scratching.

In one example, when the reinforcing layer 30 is made of tempered glass, it is preferable that the thickness of the reinforcing layer 30 is 5 to 10 mm.

In one example, a panel that is made of polymethylmethacrylate having a thickness of 2 to 4 mm or polycarbonate having a thickness of 10 to 15 mm may be additionally laminated on an outer surface of the reinforcing layer 30. In this case, it is ensured that the bullet proof effect is exhibited against a bullet having a diameter of equal to or greater than 7.62 mm in addition to an ordinary bullet having a diameter of 5.56 mm.

When the thickness of the reinforcing layer 30 is less than 5 mm, the above effects may be insignificant. When the thickness of the reinforcing layer 30 is greater than 15 mm, the above effects may not be improved significantly, but the thickness of the bulletproof panel may be excessively increased. Therefore, neither case is preferable.

The adhesive layer 20 is provided between the base layer 10 and each of the reinforcing layers 30 at a thickness of 1 to 3 mm and is made of a UV-curable urethane resin. The adhesive layer 20 serves to provide firm bonding between the base layer 10 and the reinforcing layer 30 to further improve bulletproof effect of the disclosed bulletproof panel.

The adhesive layer 20 made of a UV-curable urethane resin as described above has no adverse influence on brightness or contrast of the bulletproof panel, but is excellent in transparency, adhesion reliability, and durability. Due to these characteristics, the adhesive layer 20 serves to provide a bulletproof panel which is excellent in transparency and exhibits an excellent bulletproof effect without causing a phenomenon where the base layer 10 and the reinforcing layer 30 are delaminated.

Herein, it is preferable that a UV-curable urethane resin which contains an amount of 5 to 15% by weight of acrylic exhibiting a UV-curing effect is used. Furthermore, it is more preferable that a UV-curable urethane resin which contains an amount of 20 to 35% by weight of hard segment, with an adhesive strength of 15 to 150 MPa and an elongation of 150 to 350% is used.

The UV curable urethane resin having the above components and properties is based on the structure of polyurethane. When a linear polymer transforms into a network polymer due to radical reaction by UV irradiation, the resin undergoes a phase change from liquid to solid, thus exhibiting an adhesive force. Herein, in a molecular structure of the resin, acrylic that can undergo UV-curing reaction, that is, radical reaction, is chemically bonded and is contained in an amount of 5 to 15% by weight.

When the amount of acrylic is less than 5% by weight, the UV-curing effect of the UV-curable urethane resin may be lowered. When the amount of acrylic is greater than 15% by weight, physical properties such as elongation may be lowered.

When the thickness of the adhesive layer 20 is less than 1 mm, the above effects may be insignificant. When the thickness of the adhesive layer 20 is greater than 3 mm, the above effects may not be significantly improved, but the impact resistance of the adhesive layer 20 may be lowered. Therefore, neither case is preferable.

The bulletproof panel having the configuration described above is manufactured in such a manner that a UV-curable urethane resin is applied on opposite sides of the base layer 10 to form adhesive layers 20, and then the reinforcing layer 30 is laminated on each of the opposite sides of the base layer 10 on which the adhesive layers 20 are formed to form a laminate, and finally the laminate is put into a UV irradiation device and irradiated with ultraviolet rays for 20 to 40 minutes to provide a strong bond between the base layer 10 and the reinforcing layers 30.

Herein, the a process of forming the adhesive layers 20 on the respective opposite sides of the base layer 10 is performed in such a manner that a protective film of polymethyl methacrylate or polycarbonate used as the base layer 10 is removed, and then appearance inspection is performed to detect defects, and finally the UV-curable urethane resin is applied to the opposite sides of the base layer 10 to a thickness of 1 to 3 mm.

Hereinafter, a method for manufacturing the disclosed bulletproof panel and the physical properties of a bulletproof panel manufactured by the method will be described with reference to Examples.

### Example 1

Polymethyl methacrylate having a thickness of 5 mm was used to form a base layer. Then, an adhesive made of a UV-curable urethane resin was applied to opposite upper and lower sides of the base layer to a thickness of 2 mm to form an adhesive layer. Then, a reinforcing layer made of polycarbonate having a thickness of 10 mm was laminated on each of the opposite sides of the base layer on which the adhesive layers were formed to form a laminate, and the laminate was irradiated with ultraviolet rays for 30 minutes. As a result, a bulletproof panel in which the base layer and the reinforcing layers are bonded together was manufactured.

### Example 2

A bulletproof panel was manufactured in the same manner as in Example 1, except that polymethyl methacrylate having a thickness of 10 mm was used to form a base layer.

### Example 3

A bulletproof panel was manufactured in the same manner as in Example 1, except that polymethyl methacrylate having a thickness of 20 mm was used to form a base layer.

### Example 4

A bulletproof panel was manufactured in the same manner as in Example 1, except that a reinforcing layer made of polycarbonate having a thickness of 15 mm was laminated.

### Example 5

A bulletproof panel was manufactured in the same manner as in Example 1, except that a reinforcing layer made of tempered glass having a thickness of 5 mm was laminated.

### Example 6

A bulletproof panel was manufactured in the same manner as in Example 1, except that a reinforcing layer made of tempered glass having a thickness of 10 mm was laminated.

### Example 7

A bulletproof panel was manufactured in the same manner as in Example 1, except that a reinforcing layer made of polycarbonate and including a metallic wire mesh (made of steel) was formed.

### Comparative Example 1

Polymethyl methacrylate having a thickness of 3 mm was used to form a base layer. Then, an adhesive made of a UV-curable urethane resin was applied to opposite upper and lower sides of the base layer to a thickness of 2 mm to form an adhesive layer. Then, a reinforcing layer made of polycarbonate having a thickness of 10 mm was laminated on each of the opposite sides of the base layer on which the adhesive layers were formed to form a laminate, and the laminate was irradiated with ultraviolet rays. As a result, a bulletproof panel in which the base layer and the reinforcing layers are bonded together was manufactured.

### Comparative Example 2

A bulletproof panel was manufactured in the same manner as in Comparative Example 1, except that a reinforcing layer made of polycarbonate having a thickness of 3 mm was formed.

The bulletproof performance of the bulletproof panels manufactured through Examples 1 to 7 and Comparative Examples 1 to 2 was measured and results are shown in Table 1 below.

{Herein, the bulletproof performance was measured for 1.1 g FSP according to STANAG 2920, expressed as a value of V50}

TABLE 1

| Classification | V50 |
|---|---|
| Example1 | 564 m/s |
| Example2 | 571 m/s |
| Example3 | 580 m/s |
| Example4 | 587 m/s |
| Example5 | 601 m/s |
| Example6 | 612 m/s |
| Example7 | 785 m/s |
| Comparative Example1 | 495 m/s |
| Comparative Example2 | 463 m/s |

As shown in Table 1, it can be seen that the disclosed bulletproof panels manufactured through Examples 1 to 7 exhibited excellent bulletproof performance, with V50 values greater than 550 m/s.

Therefore, the disclosed bulletproof panels can provide the following advantages: i) an excellent bulletproof effect is exhibited because when the panel is impacted by a bullet, the bullet is fixed in the base layer and does not penetrate therethrough, ii) an excellent effect of preventing broken pieces generated by the bullet from scattering is exhibited, iii) transparency is secured by provision of the base layer and the reinforcing layers made of a transparent material, and iv) a thin structure including a metallic wire mesh is provided, thus exhibiting an excellent effect without causing a reduction in the bulletproof performance.

Although the exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A bulletproof panel, comprising:
a base layer;
a reinforcing layer provided on each of opposite sides of the base layer; and
an adhesive layer provided between the base layer and each of the reinforcing layers, and made of a UV-curable urethane resin.

2. The bulletproof panel of claim 1, wherein the base layer is made of polycarbonate or polymethyl methacrylate.

3. The bulletproof panel of claim 1 or 2, wherein the base layer has a thickness of 5 to 20 mm.

4. The bulletproof panel of claim 1, wherein the reinforcing layer is made of one selected from the group consisting of polymethyl methacrylate, polycarbonate, acrylonitrile butadiene styrene copolymer, and tempered glass.

5. The bulletproof panel of claim 1 or 4, wherein the reinforcing layer has a thickness of 5 to 15 mm.

6. The bulletproof panel of claim 1, wherein the adhesive layer has a thickness of 1 to 3 mm and is made of the UV-curable urethane resin.

7. The bulletproof panel of claim 6, wherein the UV-curable urethane resin contains acrylic in an amount of 5 to 15% by weight.

8. The bulletproof panel of claim 1, wherein the adhesive layer includes a metallic wire mesh.
